(19) United States
(12) Patent Application Publication
(10) Pub. No.: US 2022/0365917 A1
(43) Pub. Date: Nov. 17, 2022

(54) News Reporting using Subscriber-Specified Just Significant Differences

(71) Applicant: Trusted Origins Corp., Foster City, CA (US)

(72) Inventor: Frederick Roth, San Jose, CA (US)

(73) Assignee: Trusted Origins Corp., Foster City, CA (US)

(21) Appl. No.: 17/302,757

(22) Filed: May 11, 2021

(51) Int. Cl. G06F 16/22; H04L 29/08; G06F 16/2455

(52) U.S. Cl. CPC G06F 16/2246; H04L 67/10; G06F 16/24553

(57) ABSTRACT

A system and methods for news reporting using subscriber-specified just significant differences. Relevant news is sent to a user by propagating data through a tree data structure comprised of a root node and plurality of subscriber nodes connected to a plurality of leaf nodes which receive data from external data sources. The system maintains subscriptions between the leaf nodes, subscriber nodes and root node that assures propagation of value changes if they surpass thresholds specified by the user. A method for transmitting subscriber-specified just significant differences to a user by registering a statement of belief at a root node, specifying a just significant differences at subscriber nodes and leaf nodes, and establishing subscriptions between the root node and a proximal layer of subscriber nodes, between the proximal layer of subscriber nodes and a distal layer of subscriber nodes, and between the distal layer of subscriber nodes and leaf nodes.

### CROSS-REFERENCE TO RELATED APPLICATIONS

Not applicable.

### FEDERALLY ENDORSED RESEARCH

Not applicable.

### SEQUENCE LISTING OR PROGRAM

Not applicable.

### FIELD OF INVENTION

The present invention relates to distribution of relevant information. Specifically, the present invention relates to improving the trustworthiness and value of news through just-in-time notification of conditions of interest.

### BACKGROUND OF THE INVENTION

The 2020 US Presidential election was held on a Tuesday and networks called the outcome on Saturday, four days later. On the night of the election, various TV news channels provided frequent updates to viewers as votes were counted. Only states with lopsided outcomes could be meaningfully called that night. States where final vote counts were close could not be called early, for many reasons. A common reason was that ballots were counted according to a counting priority, with in-person ballots counted before mail-in ballots. Owing to the pandemic, an unprecedented number of voters mailed in their ballots, and this meant that in most battleground states early vote tallies were essentially meaningless. Pennsylvania, as an example, showed a huge advantage for the Republican candidate on Tuesday, but by Saturday that lead had been completely eliminated when most mail-in ballots were counted. This current invention aims to eliminate the reporting of meaningless interim results of this sort for consumers who opt to avoid the time, effort, and emotional costs of receiving and processing such interim insignificant blips.

### SUMMARY OF THE INVENTION

Embodiments of the present invention allow subscribers to specify for any given statement of belief what kind of change they would consider meaningful and then reports to them only when incremental results surpass that threshold. Psychologists use the term “just noticeable difference” for the smallest change in inputs an animal can detect, as when two lines differ enough to be perceived as different. We use the similar term Just Significant Difference or JSD for the magnitude of a change that a subscriber considers significant enough to warrant receiving. So, for example, prior to an election, we might wish to hear about changes in candidate approval ratings greater than 5% or changes in Monte Carlo simulations that alter the chance of a candidate winning by more than 4%. The present invention accepts those specifications and delivers news that reports on each change in expectation that surpasses the specified threshold.

Embodiments of the present invention enable providers of news to offer subscribers a service that optimizes their information processing, delivering infrequent but significant reports, rather than requiring subscribers to consume frequent, insignificant and often emotionally taxing reports. Moreover, it enables information publishers to offer consumers an opportunity to tailor information in ways that best meets their needs. Some consumers can monitor Monte Carlo simulations of predicted outcomes in one election region for changes they find significant while other consumers can wait for changes in other variables that concern them.

Embodiments of the present invention offer producers and consumers better ways to make their communications efficient, eliminating entirely the need for consumers to process data they would deem insignificant.

Embodiments of the present invention connect subscribers to black-box nodes with inaccessible inputs. Each node represents an agent that receives information pertinent to the belief it cares about. Leaf nodes represent beliefs based on external data sources, such as vote counts for a particular candidate in a particular area or the proportion of votes given to one candidate. These are the type of nodes that are frequently updated by a time-series of data coming from pollsters or vote tabulators.

Subscriber nodes represent subscribers and their beliefs. For example, one subscriber node might represent the proportion of electoral votes earned by the Democratic nominee. Each subscriber node subscribes to other subscriber nodes or leaf nodes that enable it to update its belief based on updated information from the subscribed subscriber node or leaf node. When a subscriber node subscribes to another subscriber node or a leaf node, the subscription specifies a Just Significant Difference, or JSD.

In every analytical process, a series of dependencies can be identified between every estimated value and those it depends on. Changes in the estimated value associated with the belief at any node must surpass the corresponding JSD to warrant a reevaluation of estimated belief at the subscriber node.

Subscribing consumers or users may be humans or computer-based agents. A good TV program will provide updates to its viewers when those updates are expected to be significant to the viewer. Embodiments of the current invention would allow for individual consumers to specify explicitly which intermediate and final beliefs they wish to monitor and how much change in those beliefs must occur before changes are pushed to them as “news.” As the magnitudes of the JSDs are increased, the amount of data that flows from a belief tree of nodes to its subscribers will decrease dramatically. A belief tree comprises a root node, a plurality of subscriber nodes, and a plurality of leaf nodes.

JSDs can be expressed in many different ways, including the following examples: (1) absolute value of a change above some threshold delta; (2) estimated value of a belief surpassing a threshold value; (3) percentage change beyond some threshold value; (4) rejection of a hypothesized value at a predetermined level of significance; and (5) change in a confidence interval of fixed size (e.g., 90% confidence interval around the estimated mean of some distribution) so that it newly includes or excludes a predetermined key value. These JSDs all work in similar ways to assess whether a new estimated value differs from a previous estimated value sufficiently to warrant pushing the news to the subscriber.

The JSD of type (4) is unusual, but can be used to restrict news to statistically significant results, in particular when an earlier belief can be rejected as false with a known alpha level of Type I error, such as p<0.01 for incorrectly rejecting a hypothesized value. For example, if we hypothesize that the Democrats will win at least 50% of votes in some area, we want to know when we can safely reject the hypothesis H, the Democrats' vote proportion is less than 50%. This can be done with standard statistical methods that can reject such a hypothesis using the Binomial distribution. This would be done typically with a one-tailed test, but it could also be done more conservatively with a two-tailed test. The only difference is whether we are concerned that the Democrats might win too many votes rather than too few for the purposes of using extreme data to reject the null hypothesis. Consumers who want reliable news as well as significant news will appreciate JSDs like that in (4), because such methods provide a quantification of the risks of accepting incorrect hypotheses or rejecting correct ones inappropriately.

JSD type (5) can be used for similar purposes as that just described for JSD type 4. Typically, scientists want to know when a belief they are holding becomes unlikely. For example, if they expect 60% of some group of voters will cast ballots for a Democratic candidate, they want to know when that becomes unlikely or when it becomes virtually certain. They might reason that intermediate results, although uncertain, can be good enough to react to, as when the 90% confidence interval around the estimated proportion of interest no longer includes the expected 60% figure. That would be an early indication that the hypothesis has become very unlikely. In that case, they would formulate a subscription for news indicating that the 90% confidence interval for the estimated proportion of votes cast for the Democratic candidate newly excludes 60%. Subsequent to that, they might subscribe to the same node asking for a notification when an updated confidence interval newly includes the 60% value, as when subsequent votes move the estimated proportion back closer to 60%.

The key function is to update the estimated value of a belief at a node and any additional variables associated with that hypothesis such as confidence intervals, likelihood ratios, total number of observations, proportion of total expected votes already tallied, etc. Initially, data are fed to leaf nodes from external sources, such as ballot tabulators. As the estimated value of any node's belief changes, its subscribers are identified and then individually evaluated to determine if the current value of the estimated belief or any of the related variables differ enough from the subscriber's previously received estimated value to warrant pushing the new value to it. Thus, updates propagate node to node whenever the subscribed node's new estimated belief value passes the subscriber's threshold for notification. These belief trees do not have cycles because that makes beliefs circular and tautological.

Finally, the embodiments of the present invention make it possible to use results of sensitivity analyses to determine thresholds for significant data updates. In complex models such as simulations, analysts routinely perform a sensitivity analysis. This helps them understand how their model's predictions are affected by changes in various input parameters. So, for example, one simulation might be relatively insensitive to total votes cast in an area, while the same simulation might be sensitive to significant weather events on election day. A complex set of models, combined as in FiveThirtyEight.com's US Presidential electoral votes Monte Carlo, will identify different degrees of sensitivity to different parameters. When we find that our models are relatively insensitive to a particular parameter, an embodiment of the present invention captures this by making the JSD for propagating that parameter relatively coarse or large, meaning that only big changes will be pushed to the consumer. Likewise, the JSD a consumer specifies for parameters it is highly sensitive to will be finer-grained and smaller. This enables the entire network of belief nodes to wait for significant changes before consuming them and recalculating beliefs at the consumer level.

### BRIEF DESCRIPTION OF THE DRAWINGS

FIG. 1 is a block diagram of the basic components of the system.

FIG. 2 is a block diagram of the basic components of the system.

FIG. 3 is a block diagram of the basic components of the system.

FIG. 4 is a flow chart of the process.

FIG. 5 is block diagram of the computing system.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

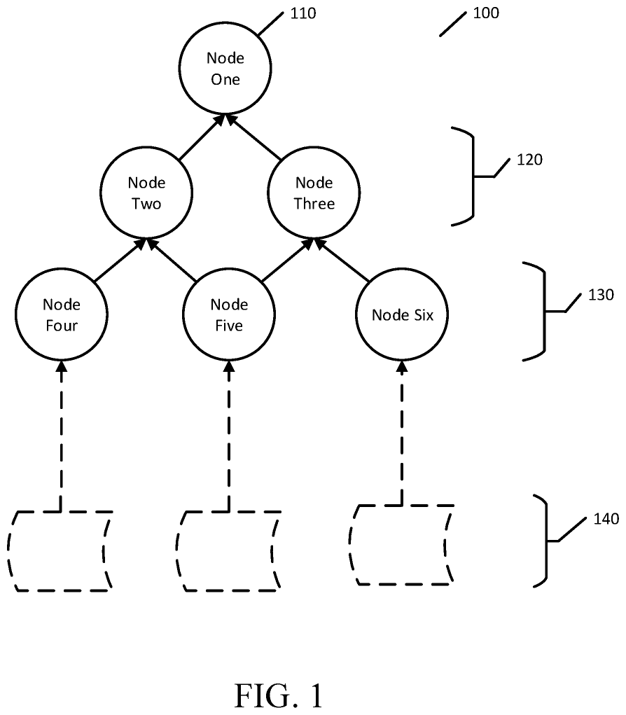

Referring to FIG. 1, shown is how one embodiment of the present invention connects subscribers to black-box nodes with inaccessible inputs. In this example, six interdependent belief nodes are shown. Each node represents an agent that receives information pertinent to the belief it cares about. The leaf nodes 130 represent beliefs based on external data sources 140, such as vote counts for a particular candidate in a particular area or the proportion of votes given to one candidate. These are the type of nodes that are frequently updated by a time-series of data coming from pollsters or vote tabulators.

Node One is the root node 110 to which a user would subscribe. Nodes Two through Node Three comprise the proximal subscriber nodes 120 and together with the root node 110, represent subscribers and their beliefs. For example, the root node 110 might represent the proportion of electoral votes earned by the Democratic nominee. Each of the proximal subscriber nodes 120 subscribes to others that enable it to update its belief based on updated information from subscribed nodes. When a root node 110 or one of the proximal subscriber nodes 120 subscribes to another node, as when Node One subscribes to Node Two, the subscription specifies a Just Significant Difference, or JSD. In this case, the Node One subscription to Node Two specifies the amount notated as JSD(1,2), which should be read as the Just Significant Difference that Node One requires for receiving updated reports from Node Two.

Consequently, we can identify a series of dependencies between every estimated value and those it depends on. As shown in FIG. 1, the root node 110 (Node One) depends on proximal subscriber nodes 120 comprising Node Two and Node Three, and Node Two depends on leaf nodes 130 comprising Node Four and Node Five, and Node Three depends on leaf nodes 130 comprising Node Five and Node Six. In this instance, Node Five is subscribed to by two proximal subscriber nodes 120. In one embodiment of the present invention, Node Five will utilize an algorithm to allocate data being forwarded to the two subscribing proximal subscriber nodes 120 so that duplicate data is not propagated through the tree data structure. Changes in the estimated value associated with the belief at any node must surpass the corresponding JSD to warrant a reevaluation of estimated belief at the subscriber node. In one embodiment of the present invention, if no JSD is specified, then a default JSD will propagate any change >0. The leaf nodes 130 in turn receive information from external data sources 140.

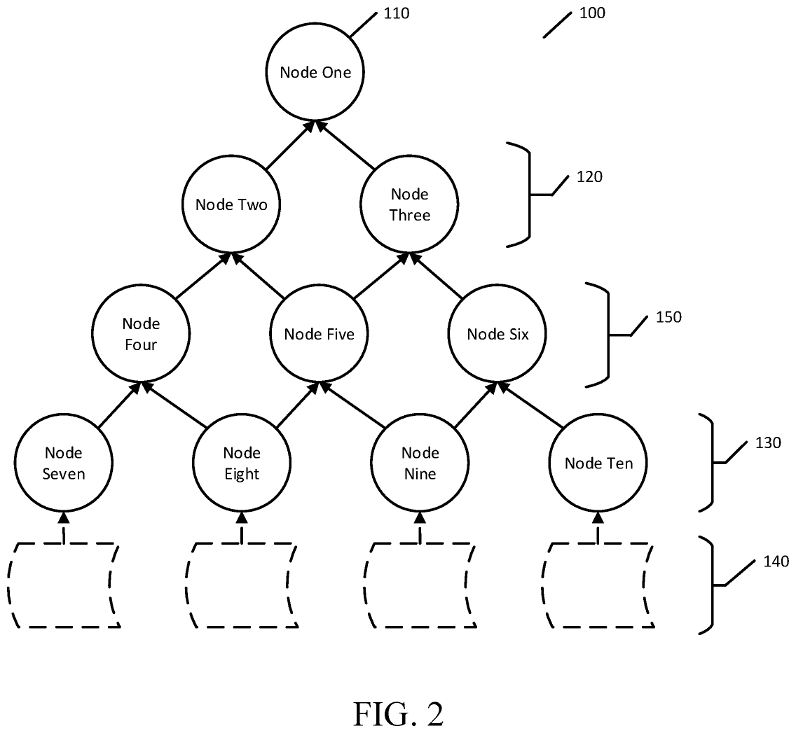

In FIG. 2, shown is how one embodiment of the present invention connects subscribers to black-box nodes with inaccessible inputs. In this example, ten interdependent belief nodes are shown. Each node represents an agent that receives information pertinent to the belief it cares about. The leaf nodes 130 represent beliefs based on external data sources, such as vote counts for a particular candidate in a particular area or the proportion of votes given to one candidate. These are the type of nodes that are frequently updated by a time-series of data coming from pollsters or vote tabulators.

Node One is the root node 110 to which a user would subscribe. Nodes Two through Node Six comprise the proximal subscriber nodes 120 and together with the root node 110, represent subscribers and their beliefs. For example, the root node 110 might represent the proportion of electoral votes earned by the Democratic nominee. Each of the proximal subscriber nodes 120 subscribes to others that enable it to update its belief based on updated information from subscribed nodes. When a root node 110 or one of the proximal subscriber nodes 120 subscribes to another node, as when Node One subscribes to Node Two, the subscription specifies a Just Significant Difference, or JSD. In this case, the Node One subscription to Node Two specifies the amount notated as JSD(1,2), which should be read as the

Just Significant Difference that Node One requires for receiving updated reports from Node Two.

In every analytical process, we can identify a series of dependencies between every estimated value and those it depends on. As shown in FIG. 2, the root node 110 (Node One) depends on proximal subscriber nodes 120 comprising Node Two and Node Three, and Node Two depends on Node Four and Node Five, Node Three depends on Node Five and Node Six, etc. Changes in the estimated value associated with the belief at any node must surpass the corresponding JSD to warrant a reevaluation of estimated belief at the subscriber node. In one embodiment of the present invention, if no JSD is specified, then a default JSD will propagate any change.

Subscribers may be humans or computer-based agents. A good TV program will provide updates to its viewers when those updates are expected to be significant to the viewer. One embodiment of the present invention would allow for individual consumers to specify explicitly which intermediate and final beliefs they wish to monitor and how much change in those beliefs must occur before changes are pushed to them as “news.” As the magnitude of the JSDs are increased, the amount of data that flows from the belief tree of nodes to its subscribers will decrease dramatically.

The belief tree in FIG. 2 has been rendered in Mathematica code for the purposes of illustrating this concept. Numbers between 0 and 1 are adopted, without limitation, to indicate the estimated value of whatever belief is associated with each node. In the election context, the most common type of belief would be the proportion of votes received by one of the two major parties. So 0.6 would indicate 60% for the associated party leaving 40% for the complement, usually the other major party, whenever a plurality is sufficient to win. When an absolute majority is required, the percentage of all votes given to the corresponding party is measured. In either case, as data arrive, the estimated value of the node's belief should be updated.

The Mathematica code shows how to create 10 nodes, specify subscriptions and JSDs. Typically, the belief tree of nodes reflect important analytical milestones in computation, such as vote tallies at the leaves, predicted winners by areas, predicted winners by electoral college boundaries (most often states), and overall winners. When an organization such as FiveThirtyEight.com does its analyses, it uses dozens of leaf nodes and subscriber nodes. Its root node corresponds to a proportion of simulated election outcomes that a particular candidate will receive or the total number of seats in Congress expected to be won by a particular party. Whenever intermediate or final results are available to subscribers, we would associate a subscriber node and its JSD to operate upon such beliefs.

JSDs can be expressed in many different ways, including the following examples: (1) absolute value of a change above some threshold delta; (2) estimated value of a belief surpassing a threshold value; (3) percentage change beyond some threshold value; (4) rejection of a hypothesized value at a predetermined level of significance; and (5) inclusion or exclusion of a particular value from a confidence interval of a specified size for some estimated value of interest, such as exclusion of 0.6 from the 90% confidence interval around the estimated proportion of votes cast for the Democratic candidate in some area of interest. These JSDs all work in similar ways to assess whether a new estimated value differs from a previous estimated value sufficiently to warrant pushing the news to the subscriber. In the example code, we show how to process changes only of type (1) above. Anyone with reasonable skills in programming would have no difficulty implementing the other subscription JSDs in a comparable manner.

The illustrative code below shows that the key function is to update the estimated value of a belief at a subscriber node. Without loss of generality, we could associate additional variable values with each such subscriber node, such as number of tallied votes or expected remaining untallied votes, etc. Initially, data are explicitly fed to leaf nodes. As the estimated value of any node's belief changes, its subscribers are identified and then individually evaluated to determine if the current value of the estimated belief differs enough from the subscriber's previously received estimated value to warrant pushing the new value to it. Thus, updates propagate node to node whenever the subscribed node's new estimated belief value surpasses the subscribing node's threshold for notification. These trees of belief nodes, or belief trees for short, should not have cycles because that makes beliefs circular and tautological. We have not illustrated the means for preventing infinite looping, but those are well known for graphs with cycles. In such cases, people adopt one or another typical method for eliminating looping.

The code below also illustrates one way to update a leaf node after initialization. In this case, we have illustrated a black-box or exogenous report that tells the system to update a leaf node's estimated value to a certain value. Leaf nodes do not subscribe to other nodes. A function is used to supply an updated value to a leaf node. After that new value is received, the new value propagates to all subscribers whose JSD thresholds are surpassed. The function updateCF[n_] is used when any non-leaf node receives news of a producer's value change in excess of that node's subscription JSD.

The code below illustrates a graceful integration and portrayal of incremental election results. With current approaches, TV stations present vote counts incrementally, regardless of where they originate or what their actual significance is. Careful analysts then investigate those questions and largely dismiss as uninformative results that do not differ significantly from expectations. A major objective of the present invention is to eliminate the whipsaw experiences consumers have as large vote counts are tallied for one opponent or another, reasonably believing that size matters. What really matters is whether incoming data confirm prior estimates or disconfirm them. In order to determine that something is worth noticing, you should first determine whether it changes your expectations and, if so, whether that new finding propagates to indicate significant changes in other beliefs. Such changes ordinarily result from a dependency upon the modified prior belief. In that case, one should recalculate the dependent belief and, as before, assess whether any change brings new information that should be passed on to those subscribing to it because their beliefs depend upon it.

The second way in which a violated expectation might impact others can also occur. In this case, small changes in many beliefs might each seem insignificant but from a different perspective might indicate a change in a common underlying variable. For example, small increments in votes in early returns might indicate a red (Republican) or blue (Democratic) shift or might indicate an increase in voter turnout. Changes in those variables might affect many other variables, as when a rising tide lifts all boats. Most of the credit for any particular rise should be attributed to the tide, not the boat.

Either type of finding, a change in a visible result or a change in an underlying variable, should be processed in the same way: (1) read the input and add it to prior data; (2) determine the change in any affected variable estimates; (3) if the estimated variable changes by enough to surpass a subscriber's JSD (Just Significant Difference), inform that subscriber. The simplest form is a dependency graph, identifying for every belief node a link to every other node it depends on and from which it must obtain data to evaluate its own model as well as the procedure it will employ to update its own belief calculations. In one embodiment, each link represents a subscription, and each subscriber specifies to the node it depends upon the rule to use in determining whether a value change at that node rises to the level of a JSD. For the purpose of assessing each subscription, we compare how much change has occurred since that last value was pushed to the subscriber. When the difference between current estimated value at a node and the value last communicated to a subscriber surpasses the subscription's JSD, the subscriber is notified of the new value and a record is retained of that communicated value. Different subscribers may receive pushed updates at different moments, reflecting differences in their individual JSDs.

Embodiments of the present invention could provide modelers for a few basic, common node types, including: (1) total ballots expected for a particular vicinity; (2) votes tallied thus far for a particular vicinity; (3) votes for a particular candidate within a particular vicinity; (4) expected proportion of votes for Democratic party nominee in a particular vicinity; and (5) expected proportion of votes for a Democratic candidate that will come as mail-in vs. in-person. Many other such variables could also be tracked.

Consider as an example, a belief node that expects at the outset of an election 76% of total votes in a particular area to be cast for the Republican candidate. So when the first 8000 votes go to the Republican candidate and 2000 go to the Democrat, a subscriber might want to know if that's significantly different from expectation. Supposing the prior balance of votes in the same vicinity was 0, would a deviation of 400 votes from expectation out of 10000 exceed the JSD of a subscriber? Suppose the subscriber believes his modeling should be insensitive to very small errors in estimated proportion r of votes going to the Republican using a Binomial distribution treating each successive vote a draw from a random urn with r proportion of Republican balls and 1-r proportion of Democratic balls. So a subscriber might want to be notified when the current data are sufficient to reject the hypothesis that the true r is between 0.74 and 0.78. Whenever one does hypothesis testing this way, there is always a possibility of mistakenly rejecting a true hypothesis and most experts require a low chance of such incorrect rejections, usually requiring p<0.05 or p<0.01. This is what statisticians call statistical “significance”, namely the level of risk associated with rejecting an hypothesis prematurely. The simplest form of a JSD would be one that specified the hypothesis and the statistical significance level required. In this case, H: 0.74≤r≤0.78, p<0.01. Note that early on, when few independent data have come in, a bigger deviance from expectation will be required to reject the hypothesis, but because the density distribution of expected outcomes becomes narrow as the total number of observations increases, even a small fractional deviation among millions of votes will be detected.

An alternative nearly equivalent method often adopted for the same kind of problem uses confidence intervals around the current best estimate of the variable of interest. Following the previous example, we could establish a subscription that asks for an update whenever the 99% confidence interval around the most recent estimate of r no longer contains the value 0.76. In that case, the subscriber can reject the original hypothesis of r=0.76 with only a 1% chance of being wrong.

As an example of an implantation addressing a current problem, take the example of media, especially television stations, providing updates on an election. With current approaches, television stations present vote counts incrementally, regardless of where they originate or what their actual significance is. Careful analysts then investigate those questions and largely dismiss as uninformative results that do not differ from expectations. The purpose of the present invention is to eliminate the whipsaw experiences viewers have as large vote counts are tallied for one opponent or another, thinking that size matters. What really matters is whether incoming data confirm prior estimates or disconfirm them. In order to determine that something is worth noticing, you should first determine whether it changes your expectations and, if so, whether that new finding propagates to indicate significant changes other beliefs. Such changes might result from a dependency upon the modified prior belief. In that case, one should recalculate the dependent belief and, as before, assess whether any change brings new information that should be passed on to those dependent upon it. There is a second way in which a violated expectation might impact others can occur. In this case, small changes in many beliefs might each seem insignificant, but from a different perspective might indicate a change in a common underlying variable. For example, small increments in votes in early returns might indicate a red or blue shift or might indicate a turnout increase. Changes in those variables might affect many other variables, as when a rising tide lifts all boats. Most of the credit for any particular rise should be attributed to the tide, not the boat. With either type of finding, a change in a visible result or a change in an underlying variable, should be processed in the same way as follows: (1) read the input and add it to prior data; (2) determine the change in any affected variable estimates; and (3) if the variable estimated changes by a subscriber's jsdCF (just significant difference), inform that subscriber.

In one embodiment of the present invention a dependency graph is used, identifying for every belief node a link to each other node it must obtain data from in order to evaluate its own model and the process it must follow to update its own belief. Each link represents a subscription, and each subscriber specifies to a node the rule to use in determining whether a change rises to the level of a Just Significant Difference (JSD). For the purpose of each subscriber, the JSD is computed using the last pushed update as the base against which the current best estimate is compared. Different subscribers may receive pushes at different moments, reflecting differences in their personal JSDs.

The simplest form of a jsdCF is one that specifies the hypothesis and the statistical significance level required. In this case, H: 0.78<=r<=0.82, p<0.01. Note that early on, when few independent data have come in, a bigger deviance from expectation will be required to reject the hypothesis, but because the density distribution of expected outcomes becomes narrow as the total number of observations increases, even a small deviation among millions of votes will be detected.

In one embodiment of the present invention, models are constructed that generate expected votes in various localities and using various modalities, to feed these results into dependent calculations such as Monte Carlo simulations of outcomes in a larger collection (e.g., town, city, district, region, state, nation). Model builders routinely conduct sensitivity analyses to learn what size changes in independent variables (taken from other nodes) affect their outcomes. They then subscribe to providers of those variables using some proportion (such as 75%) of those deltas that are known to have material changes to their own model's expected results.

In general, a node is built wherever someone requires an input, an estimate of a proportion, and where deviation in that estimated proportion can be detected with statistical significance. Detecting the deviation means rejecting the hypothesis of a variable being within some expected range. A display can determine psychologically and perceptually significant news automatically and show it, while at the same time keeping insignificant data from bombarding the receiver. While this would make television boring, it would reduce the amount of data transmitted and the amount of data received by orders of magnitude. When only actual news is transmitted, some studies indicate a reduction of data processing loads as high as 99.999% (5 orders of magnitude).

There are many ways to compute expected values and to test and reject hypotheses. Embodiments of the present invention can incorporate any of them; embodying the subscription to required sources along with subscriber-specified JSDs. This permits each node to determine when changes in its expectations warrant notifying a subscriber, and then pushing the news to the subscriber. Many belief graphs have cycles, so iterations must be limited somehow to avoid infinite looping. Models themselves can be modified at any time, with no special changes required.

FIG. 2 illustrates a model with ten nodes. In this model, nodes[j]={estimator function j, current estimate j, subscribers j}, where each subscriber in the set of subscribers j={subscriber node j k, last update j k, just significant delta j k}. Whenever a node's current estimate changes, an assessment is made as to which subscribers should be notified. For each subscriber node j k, if the current estimate differs from the last update j k more than just significant delta j k, the current estimate is pushed to subscriber node j k and then that node's current estimate is recomputed, and the same logic is applied. In this example, we use JSDs for passing along only those changes that indicate the 90% confidence interval no longer contains a pre-specified expected proportion of votes being cast for the Democratic candidate. Consequently, each node has to maintain both the total votes cast totVotes and the number of those cast for the Democratic candidate demVotes. The JSDs specify the expected proportion for the Democratic candidate.

Continuing with FIG. 2, the ten nodes are situated in a belief tree 100 comprising four rows, where Node One 110 is the root node which subscribes to the second row of proximal subscriber nodes 120 comprising Node Two and Node Three. Node Two and Node Three in turn subscribe to nodes in the third row of distal subscriber nodes 150 comprising Node Four, Node Five and Node Six. Node Four, Node Five and Node Six in turn subscribe to leaf nodes 130 in the fourth row comprising Node Seven, Node Eight, Node Nine and Node Ten.

Each node responds to any change greater than 0.05. The estimator function is to average the two inputs. For illustration purposes, this tetractys models a situation where some votes flow up to different nodes, as when intermediate nodes combine partial results from diverse sources to help them best assess key intervening analytic estimators. In this model, votes tallied in Node Five, Node Eight and Node Nine are partitioned between their subscribers to avoid counting any vote twice. In this example, votes tallied in Node Five are allocated 70% to Node Two and 30% to Node Three. Votes tallied from Node Eight are allocated 80% to Node Four and 20% to Node Five. Votes tallied from Node Nine are allocated 50% to Node Five and 50% to Node Six. Each time a node is updated, it receives two inputs: totVotes and demVotes, representing additional total votes and additional votes for the Democrat.

After the initial inputs have been received and the node initialized, then the model will recompute proportion of votes for Dem across all inputs at node n, then notify any subscriber of the new estimate if the new estimate excludes the subscriber's JSD from the newly computed 90% confidence interval and this was not previously reported, i.e. when signalCFoutOfCI==False. Conversely, if the CI now actually contains the JSD and signalCFoutOfCI==True, it will push the new values. In either case, when pushing the new value, the system will also switch the value of signalCFoutOfCl to reflect the change was signaled, as shown in the following Mathematica code. Throughout this code, the letters “CF” have been used to indicate a “Certainty Factor”, the estimated proportion of votes the Democratic candidate wins in the region associated with that node. So terms such as “updateCF” and “jsdCF” indicate functions such as updating the estimated CF or a subscriber's JSD for a change in that estimated Democractic vote. Throughout this code, the letters “CI” have been used to indicate a “Confidence Interval”. The Mathematica code follows below, with numerous Print statements included that execute when a flag called “debug” is True.

```
updateCF[n_] := Module[{jnode = n, votePair, sigma, k, subscriber,
nowOut, cf},
  votePair = {totVotes[jnode], demVotes[jnode]};
  If[debug,
    Print[“updateCF at node=”, jnode, “ votePair=”, votePair]];
  If[totVotes[jnode] > 0,
    proDem[jnode] = N[demVotes[jnode]/totVotes[jnode], 3],
    proDem[jnode] = 0];
  If[debug,
    Print[“UpdateCF at node=”, jnode, “ totVotes=”, totVotes[jnode],
    “ demVotes=”, demVotes[jnode], “ proDem=”, proDem[jnode]]];
  If [Length[subs[jnode]] < 1, Return]; (* no subscribers *)
  For [k = 1, k <= Length[subs[jnode]], k++,
    subscriber = subs[jnode][[k]];
    cf = jsdCF[jnode, subscriber]; (*
    critical value of CF to report if no longer in/out of 90% CI *)
        sigma = Sqrt[totVotes[jnode]*cf*(1 − cf)];
    If [(demVotes[jnode] <
        cf* totVotes[jnode] − 2*sigma ) || (demVotes[jnode] >
        cf* totVotes[jnode] + 2*sigma ), nowOut = True,
    nowOut = False];
    If[debug,
    Print[“Subscriber=”, subscriber, “required value cf=”, cf,
      “ nowOut=”, nowOut, “ demVotes=”, demVotes[jnode], “ CI=[”,
      cf* totVotes[jnode] − 2*sigma , “, ”,
      cf* totVotes[jnode] + 2*sigma , “]”]];
    If[neverUpdated[subscriber, jnode],
    (* Need to push votes up to never updated subscriber node *)
      neverUpdated[subscriber, jnode] = False;
    If[debug,
      Print[“Subscriber never previously updated, so update now”]];
    updateCF[subscriber];
    Goto nextSubscriber;
    ];
    If [nowOut && signalCFoutOfCI[subscriber, jnode],
    If[debug,
      Print[“NowOut is True and was previously outOfCI also, so just \
return”]];
    Goto nextSubscriber];(*
    updated proportion remains out of the CI *)
    If[nowOut,
    If[debug,
      Print[“NowOut has become True for node=”, jnode,
      “ so update subscriber=”, subscriber]];
    signalCFoutOfCI[subscriber, jnode] = True;
    (* Push sigificant change to subscriber and note our of CI has \
been signaled *)
    updateCF[subscriber];
    Goto nextSubscriber];
    If[debug, Print[“CF must now be inside the CI”]];
    (* The CF is inside the CI *)
    If[signalCFoutOfCI[subscriber, jnode] == False,
    If[debug,
      Print[“Required cf now falls inside the CI and also previously \
was inside the CI, so Return”];
      Goto nextSubscriber]];
    If[debug,
    Print[“cf is now inside CI and was previously outside that CI, \
so update the subscriber=”, subscriber]];
    signalCFoutOfCI[subscriber, jnode] = False; (*
    Change signal to False *)
    updateCF[subscriber];
    Label[nextSubscriber];
    ];
  ];
```

Votes data are fed into the leaf nodes 130 from external data sources, as shown in the Mathematica code below:

```
addLeafVotes[n0_, tV0_, tD0_] :=
  Module[{jnode = n0, totV = tV0, totD = tD0, nowOut, tallied, knode},
    totVotes[jnode] = totVotes[jnode] + totV;
    demVotes[jnode] = demVotes[jnode] + totD;
    proDem[jnode] = demVotes[jnode]/totVotes[jnode];
    If[debug,
    Print[“UpdateLeafVotes at node=”, jnode, “ totVotes=”,
      totVotes[jnode], “ demVotes=”, demVotes[jnode]]];
    (* update vote counts to all subscribers up the tree *)
      (* Now update the tally of votes for all nodes with appropriate
      proportionate shares for nodes whose votes support two or more
      different aggregating regions, such as when node 9 supplies 50%
      of its votes to nodes 5 and 6, as shown in the first two lines
      below: *)
    totVotes[6] = totVotes[10] + totVotes[9]*.5;
    totVotes[5] = totVotes[9]*.5 + totVotes[8]*.2;
    totVotes[4] = totVotes[7] + totVotes[8]*.8;
    totVotes[3] = totVotes[5]*.3 + totVotes[6];
    totVotes[2] = totVotes[5]*.7 + totVotes[4];
    totVotes[1] = totVotes[2] + totVotes[3];
    demVotes[6] = demVotes[10] + demVotes[9]*.5;
    demVotes[5] = demVotes[9]*.5 + demVotes[8]*.2;
    demVotes[4] = demVotes[7] + demVotes[8]*.8;
    demVotes[3] = demVotes[5]*.3 + demVotes[6];
    demVotes[2] = demVotes[5]*.7 + demVotes[4];
    demVotes[1] = demVotes[2] + demVotes[3];
    If[debug,
    For[knode = 1, knode <= numNodes, knode++,
      Print[“Tallied votes at node=”, knode,
      “ =”, {totVotes[knode], demVotes[knode]}]]];
    If [Length[subs[jnode]] < 1, Return];
    For [k = 1, k <= Length[subs[jnode]], k++,
    subscriber = subs[jnode][[k]];
    cf = jsdCF[jnode, subscriber]; (*
    critical value of CF to report if no longer in/out of 90% CI *)
        sigma = Sqrt[totVotes[jnode]*cf*(1 − cf)];
    If [(demVotes[jnode] <
        cf* totVotes[jnode] − 2*sigma ) || (demVotes[jnode] >
        cf* totVotes[jnode] + 2*sigma ), nowOut = True,
      nowOut = False];
    If[debug,
      Print[“cf=”, cf, “ nowOut=”, nowOut, “ demVotes=”,
      demVotes[jnode], “ CI=[”, cf* totVotes[jnode] − 2*sigma , “, ”,
        cf* totVotes[jnode] + 2*sigma , “]”]];
    If[neverUpdated[subscriber, jnode],
      If[debug,
      Print[“Subscriber=”, subscriber, “ never updated by jnode=”,
        jnode, “ so update now”]];
      (* Need to push votes up to never updated subscriber node *)
        neverUpdated[subscriber, jnode] = False;
      updateCF[subscriber];
      Goto nextSubscriber;
      ];
    If [nowOut && signalCFoutOfCI[subscriber, jnode],
      If[debug,
      Print[“Returning because nowOut and signalCFout both true”]];
      Goto nextSubscriber];(*
    updated proportion remains out of the CI *)
    If[nowOut,
      If[debug, Print[“NowOut, updating subcriber =”, subscriber]];
      signalCFoutOfCI[subscriber, jnode] = True,
      updateCF[subscriber] (*
      Push sigificant change to subscriber and note our of CI has been \
signaled *)
      ];
    (* The CF is inside the CI *)
    If[signalCFoutOfCI[subscriber, jnode] == False,
      If[debug,
      Print[“CF was previously inside CI and still is, so finished \
this subscriber”]];
      Goto nextSubscriber];
      (* Was previously inside CI and is still inside CI *)
    signalCFoutOfCI[subscriber, jnode] = False; (*
    Change signal to False *)
    If[debug,
      Print[“CF was previously inside CI but is now outside, so \
updating subscriber=”, subscriber]];
    updateCF[subscriber];
    Label[nextSubscriber]]
    ];
```

In this election example, a user may subscribe to root node 110 Node One for the assertion that a Democrat wins the election. Root node 110 Node One is supported by layers of subscriber nodes 120. At the first layer, root node 110 Node One subscribes to and depends on proximal subscriber nodes 120 Node Two and Node Three. In this example, the subscription received by Node Two is that Node One should be notified if Node Two's confidence interval (CI) no longer contains 0.5 (jsdCF[2,1]=0.5). The subscription received by Node Three is that Node One should be notified if Node Three's CI no longer contains 0.5 (jsdCF[3,1]=0.5).

At the second layer, Node Two subscribes to and depends on Node Four and Node Five. In this example, the subscription received by Node Four is that Node Two should be notified if Node Four's CI no longer contains 0.8 (jsdCF[4,2]=0.8). A subscription received by Node Five is that Node Two should be notified if Node Five's CI no longer contains 0.6 (jsdCF[5,2]=0.6). Also at the second layer, Node Three subscribes to and depends on Node Five and Node Six. In this example, a subscription received by Node Five is that Node Three should be notified if Node Five's CI no longer contains 0.6 (jsdCF[5,3]=0.6). The subscription received by Node Six is that Node Three should be notified if Node Six's CI no longer contains 0.1 (j sdCF[6,3]=0.1).

At the third layer, Node Four subscribes to and depends on Node Seven and Node Eight. In this example, the subscription received by Node Seven is that Node Four should be notified if Node Seven's CI no longer contains .8 (jsdCF[7,4]=0.8). A subscription received by Node Eight is that Node Four should be notified if Node Eight's CI no longer contains 0.8 (jsdCF[8,4]=0.8). Also at the third layer, Node Five subscribes to and depends on Node Eight and Node Nine. A subscription received by Node Eight is that Node Five should be notified if Node Eight's CI no longer contains 0.8 (jsdCF[8,5]=0.8). A subscription received by Node Nine is that Node Five should be notified if Node Nine's CI no longer contains 0.6 (jsdCF[9,5]=0.6). Also, at the third layer, Node Six subscribes to and depends on Node Nine and Node Ten. A subscription received by Node Nine is that Node Six should be notified if Node Nine's CI no longer contains0.6 (jsdCF[9,6]=0.6). The subscription received by Node Ten is that Node Six should be notified if Node Nine's CI no longer contains0.1 (jsdCF[10,6]=0.1).

At the fourth layer, the leaf nodes 130 comprising Node Seven, Node Eight, Node Nine and Node Ten each subscribe to external data sources, and accumulate vote tallies. In an example, leaf Node Seven receives information from an external data source with a vote tally of 1000 votes cast with 900 votes going to the Democrat. Since this is the first receipt of information, there will be a significant change warranting a notification to all subscribing nodes. In this case, Node Four will be notified of the vote tally by Node Seven, and Node Four will notify Node Two, and Node Two will notify Node One, and each of those nodes will register totVotes=1000 and demVotes=900.

Following the example, leaf Node Ten receives information from an external data source with a vote tally of 500 votes cast with 200 votes going to the Democrat. Since this is the first receipt of information for Node Six and Node Three, there will be a significant change warranting a notification to subscribing Node Six and Node Three. In this case, Node Six will be notified of the vote tally by Node Ten and register a vote tally of totVotes=500 and demVotes=200. Node Six will notify Node Three which will register a vote tally of totVotes=500 and demVotes=200. Node One has subscribed for notification if Node Three's CI no longer contains0.5 (jsdCF[3,1]=0.5). The cf was previously outside the CI, so Node Three notifies Node One which now registers totVotes=1500 and demVotes=1100.

Following the example, leaf Node Eight receives information from an external data source with a vote tally of 950 votes cast with 800 votes going to the Democrat. Node Eight has subscriptions from Node Four and Node Five. Node Four has subscribed for notification if Node Eight's CI no longer contains 0.8 (jsdCF[8,4]=0.8). The cf (proportion of democratic vs. total votes) was previously outside the CI, so Node Eight notifies Node Four which now registers totVotes=1760 and demVotes=1540. Node Five has subscribed for notification if Node Eight's CI no longer contains 0.8 (jsdCF[8,5]=0.8). The cf was previously outside the CI, so Node Eight notifies Node Four which now registers totVotes=190 and demVotes=160. Node Four has a subscription from Node Two. Node Two has subscribed for notification if Node Four's CI no longer contains 0.8 (jsdCF[4,2]=0.8). The cf was previously outside the CI, so Node Four notifies Node Two which now registers totVotes=1893 and demVotes=1652. Node Five has subscriptions from Node Two and Node Three. Node Two has subscribed for notification if Node Five's CI no longer contains 0.8 (jsdCF[5,2]=0.8). The cf was previously outside the CI, so Node Four notifies Node Two which now registers totVotes=1893 and demVotes=1652. Node Three has subscribed for notification if Node Five's CI no longer contains0.6 (jsdCF[5,3]=0.6). The cf was previously outside the CI, so Node Five notifies Node Three which now registers totVotes=557 and demVotes=248. Node Two and Node Three each have a subscription from Node One. Node One has subscribed for notification if Node Two's CI no longer contains0.5 (jsdCF[2,1]=0.5). The cf was previously outside the CI, so Node Two notifies Node One which now registers totVotes=2450 and demVotes=1900. Node One has subscribed for notification if Node Three's CI no longer contains 5 (jsdCF[3,1]=0.5). The cf was previously outside the CI, so Node Three notifies Node One which now registers totVotes=2450 and demVotes=1900.

Following the example, leaf Node Nine receives information from an external data source with a vote tally of 1100 votes cast with 700 votes going to the Democrat. Node Nine has subscriptions from Node Five and Node Six. Node Five has subscribed for notification if Node Nine's CI no longer contains0.6 (jsdCF[9,5]=0.6). The cf was previously outside the CI, so Node Nine notifies Node Five which now registers totVotes=740 and demVotes=510. Node Six has subscribed for notification if Node Nine's CI no longer contains0.6 (jsdCF[9,6]=0.6). The cf was previously outside the CI, so Node Nine notifies Node Six which now registers totVotes=1050 and demVotes=550. Node Five has subscriptions from Node Two and Node Three. Node Two has subscribed for notification if Node Five's CI no longer contains0.6 (jsdCF[5,2]=0.6). The cf was previously outside the CI, so Node Five notifies Node Two which now registers totVotes=2278 and demVotes=1897. Node Three has subscribed for notification if Node Five's CI no longer contains0.6 (jsdCF[5,3]=0.6). The cf was previously outside the CI, so Node Five notifies Node Three which now registers totVotes=1272 and demVotes=703. Node Six has a subscription from Node Three. Node Three has subscribed for notification if Node Six's CI no longer contains0.1 (jsdCF[6,3]=0.1). The cf was previously outside the CI, so Node Six notifies Node Three which now registers totVotes=1272 and demVotes=703. Node Two and Node Three each have a subscription from Node One. Node One has subscribed for notification if Node Two's CI no longer contains0.5 (jsdCF[2,1]=0.5). The cf was previously outside the CI, so Node Two notifies Node One which now registers totVotes=3550 and demVotes=2600. Node One has subscribed for notification if Node Three's CI no longer contains 5 (jsdCF[3,1]=0.5). The cf was previously outside the CI, so Node Three notifies Node One which now registers totVotes=3550 and demVotes=2600.

In one embodiment of the present invention, models are constructed that generate expected votes in various localities and using various modalities, to feed these results into dependent calculations such as Monte Carlo simulations of outcomes in a larger collection (e.g., town, city, district, region, state, nation). Model builders routinely conduct sensitivity analyses to learn what size changes in independent variables (taken from other nodes) affect their outcomes. They then subscribe to providers of those variables using some proportion (such as 75%) of those deltas that are known to have material changes to their own model's expected results. In general, a node is built wherever someone requires an input, an estimate of a variable, and where deviation in that estimated proportion can be detected with statistical significance. Detecting the deviation means rejecting the hypothesis of a variable being within some expected range.

A display that adapts to such estimates and significant deviations can select psychologically and perceptually significant news automatically and show it, while at the same time keeping insignificant data from bombarding the receiver. While it would make TV reporting less volatile, it would reduce the amount of data transmitted and the amount of data received by orders of magnitude. When only news is transmitted, some studies indicate a reduction of data processing loads as high as 99.999% (5 orders of magnitude). There are many ways to compute expected values and to test and reject hypotheses. The present invention can incorporate any of them. The key idea is the subscription to required sources along with subscriber-specified JSDs. This permits each node to determine when changes in its expectations warrant notifying a subscriber, and then push that news to the subscriber.

Finally, embodiments of the present invention make it possible to use results of sensitivity analyses to determine thresholds for significant data updates. In complex models such as simulations, analysts routinely perform a sensitivity analysis. This helps them understand how their model's predictions are affected by changes in various input parameters. So, for example, one simulation might be relatively insensitive to total votes cast in an area, while the same simulation might be sensitive to significant weather events on election day. A complex set of models, combined as in FiveThirtyEight's electoral Monte Carlo, will identify different degrees of sensitivity to different parameters. When we find that our models are relatively insensitive to a particular parameter, our invention captures this by making the JSD for propagating that parameter relatively coarse or large, meaning that only big changes will be pushed to the consumer. Likewise, the JSD a consumer specifies for parameters it is highly sensitive to will be finer-grained and smaller. This enables the entire network of beliefs to wait for significant changes before consuming them and recalculating beliefs at the consumer level.

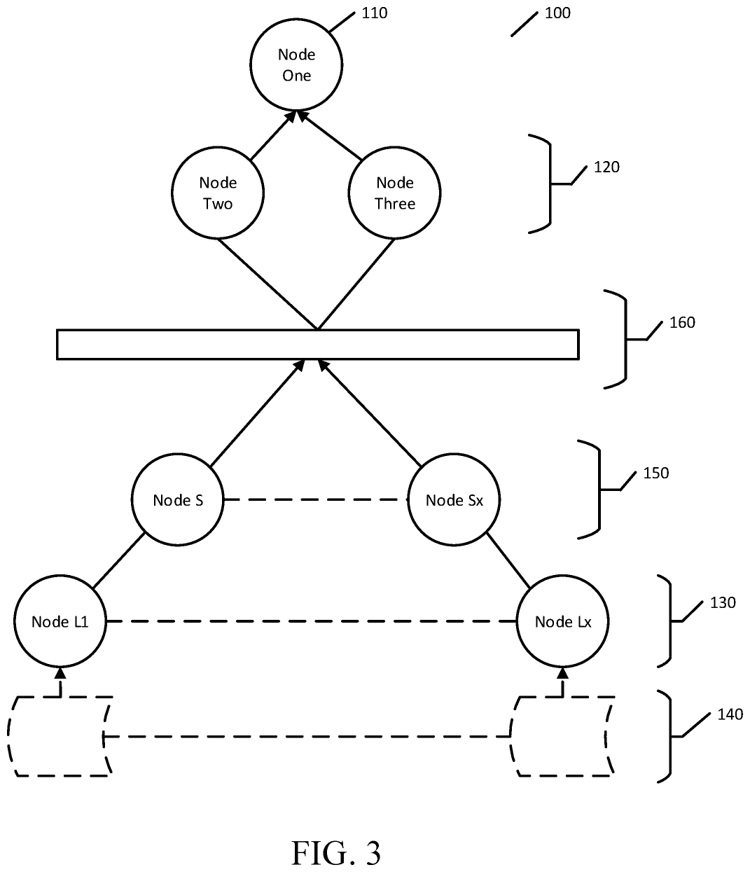

Referring to FIG. 3, shown is a belief tree with greater than three layers of subscriber nodes. Each node represents an agent that receives information pertinent to the belief it cares about. The leaf nodes 130 represent beliefs based on external data sources 140.

Node One is the root node 110 to which a user would subscribe. Node Two through Node Three comprise the proximal subscriber nodes 120, and Node S through Node Sx comprise the distal subscriber nodes 150, and between the proximal subscriber nodes 120 and he distal subscriber nodes 150 are a plurality of intermediate subscriber nodes 160, and together with the root node 110, represent subscribers and their beliefs. Each of the proximal subscriber nodes 120, intermediate subscriber nodes 160 and distal subscriber nodes 150 subscribes to other nodes that enable it to update its belief based on updated information from subscribed nodes. When a root node 110 or one of the proximal subscriber nodes 120, intermediate subscriber nodes 160 or distal subscriber nodes 150 subscribes to another node, as when Node One subscribes to Node Two, the subscription specifies a Just Significant Difference, or JSD. In this case, the Node One subscription to Node Two specifies the amount notated as JSD(1,2), which should be read as the Just Significant Difference that Node One requires for receiving updated reports from Node Two.

As shown in FIG. 3, the root node 110 (Node One) depends on proximal subscriber nodes 120 comprising Node Two and Node Three, and Node Two depends on one of a plurality of intermediate subscriber nodes 160, Node Three depends on one of a plurality of intermediate subscriber nodes 160. Each one of a plurality of intermediate subscriber nodes 160 may subscribe to another one of a plurality of intermediate subscriber nodes 160, as long as the tree structure remains acyclic. Ultimately, each one of some set of intermediate subscriber nodes 160 will subscribe to a distal subscriber node 150. In this case, the number of distal subscriber nodes comprising Node S through Node Sx will depend on the number of intermediate subscriber nodes 160 subscribing to distal subscriber nodes 150. Each node in the set of distal subscriber nodes 150 will subscribe to a leaf node 130. In this case, the number of leaf nodes comprising Node L1 through Node Lx will depend on the number of distal subscriber nodes 150 subscribing to leaf nodes 130. Changes in the estimated value associated with the belief at any node must surpass the corresponding JSD to warrant a reevaluation of estimated belief at the subscriber node. The leaf nodes 130 in turn receive information from external data sources 140.

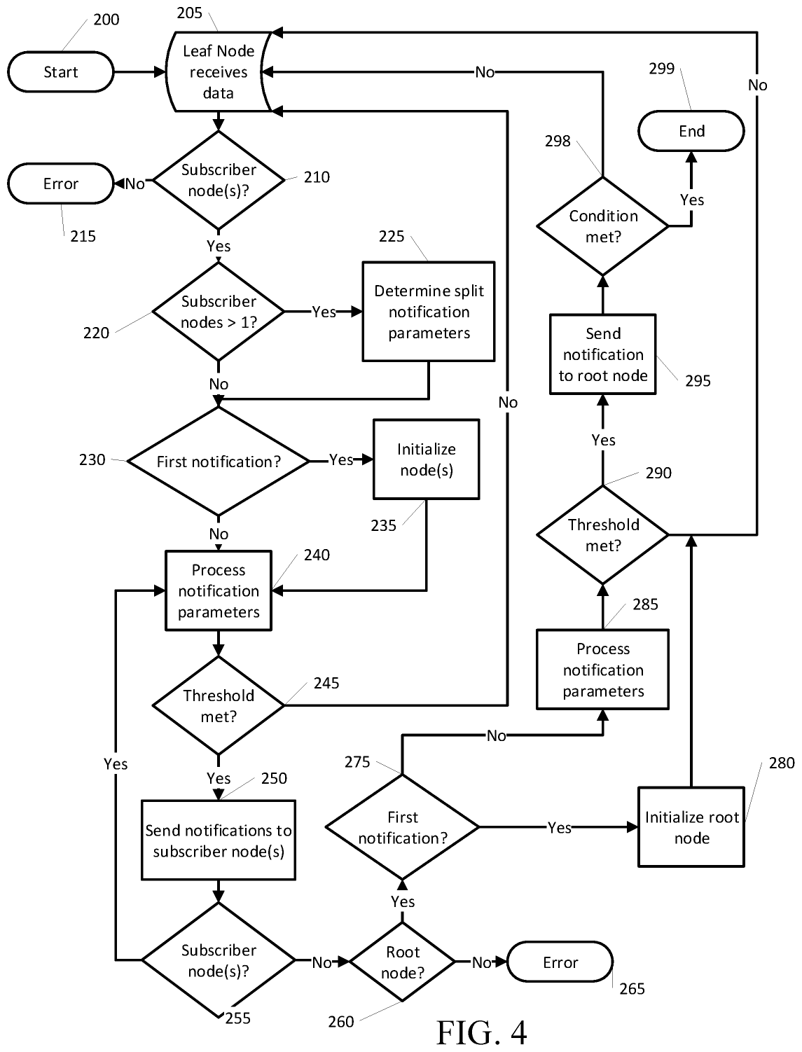

Turning now to FIG. 4, shown is the process for reporting news using subscriber-specified JSDs. Once a user has registered interest in a root node 200, the system will receive data from external data sources at the leaf nodes. When data is received at a leaf node 205, the leaf node then determines whether there are any subscriber nodes 210 subscribing for a JSD notification. If there are no subscriber nodes 215, then no assessment needs to be made, and this is most likely an error condition. When the leaf node has identified any subscribing leaf nodes, if there is more than one subscriber node subscribing for a JSD notification 220, then the leaf node will check to see if there is a split in the notification parameters 225 between the multiple subscribing subscriber nodes. Referring back to FIG. 2 as an example, leaf nodes Node Eight and Node Nine each have two subscribing distal subscriber nodes. Returning to FIG. 4, the leaf node will then determine if this is the first notification 230 to the subscribing subscriber nodes. If it is the first notification, the leaf node will send an initialization notification to the subscribing subscriber nodes 235. If it is not the first notification to the subscribing subscriber nodes, the leaf node will process the notification parameters 240 to determine if the JSD notification threshold is met 245. If the JSD notification threshold is not met, then no JSD notification will be sent to the subscribing subscriber node, and the leaf node will continue to listen for external data 205. If the JSD notification threshold is met, then the leaf node will send JSD notifications to subscribing subscriber nodes 250.

Continuing with FIG. 4, each subscribing subscriber node that receives a JSD notification will then need to identify any subscribing subscriber nodes 255. If there is more than one subscriber node subscribing for a JSD notification 220 from that subscriber node, then the subscriber node will check to see if there is a split in the notification parameters 225 between the multiple subscribing subscriber nodes. Referring back to FIG. 2 as an example, subscriber node Node Five has two subscribing subscriber nodes. Returning to FIG. 4, the subscriber node will then determine if this is the first notification 230 to the subscribing subscriber nodes. If it is the first notification, the subscriber node will send an initialization notification to the subscribing subscriber nodes 235. If it is not the first notification to the subscribing subscriber nodes, the subscriber node will process the notification parameters 240 to determine if the JSD notification threshold is met 245. If the JSD notification threshold is not met, then no JSD notification will be sent to the subscribing subscriber node. If the JSD notification threshold is met, then the subscriber node will send JSD notifications to subscribing subscriber nodes 250.

Continuing with FIG. 4, if there are no subscribing subscriber nodes, the subscriber node then determines whether there is a root node 260 subscribing for a JSD notification. If there is no subscribing root node 265, then no assessment needs to be made, and this is most likely an error condition. When the subscriber node has identified a subscribing root node, it will then determine if this is the first notification 275 to the subscribing root node. If it is the first notification, the subscriber node will send an initialization notification to the subscribing root node 280. If it is not the first notification to the subscribing root node, the subscriber node will process the notification parameters 285 to determine if the JSD notification threshold is met 290. If the JSD notification threshold is not met, then no JSD notification will be sent to the subscribing subscriber node, and the leaf node will continue to listen for external data 205. If the JSD notification threshold is met, then the subscriber node will send the JSD notification to subscribing root node 295. If that JSD notification satisfies the condition for which the user registered an interest with the root node 298, then the process will conclude 299. Otherwise, the leaf node will continue to listen for external data 205.

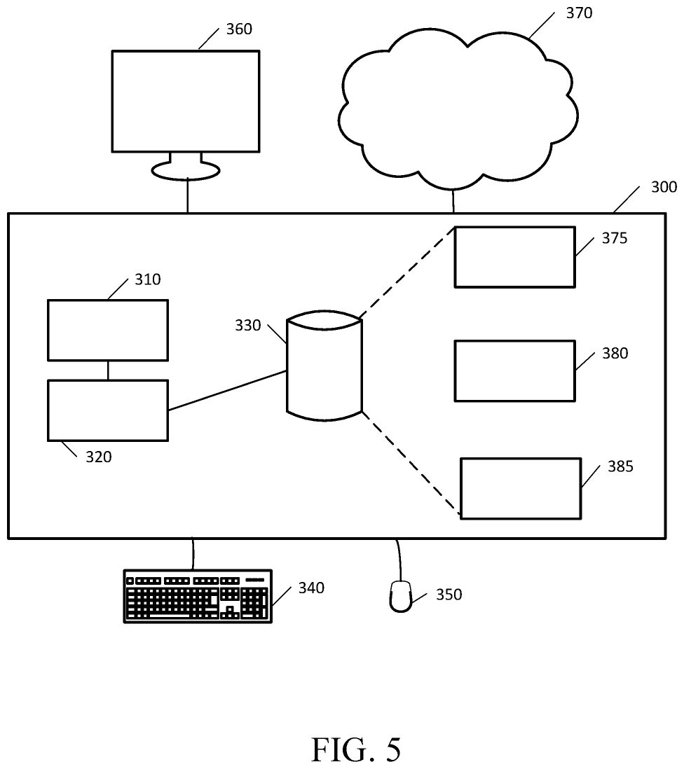

FIG. 5 illustrates an exemplary system for processing JSD notifications, in accordance with an embodiment of the present invention. A system 300 for reporting news using subscriber-specified JSDs comprises a processor 310, a memory 320, and a storage 330. Storage 330 typically stores instructions that can be loaded into memory 320 and executed by processor 310 to perform the methods mentioned above. In one embodiment, the instructions in storage 330 can implement an external data source module 375, a node state module 380, and a JSD processing module 385, all of which can be in communication with each other.

In some embodiments, modules 375, 380, and 385 can be partially or entirely implemented in hardware and can be part of processor 310. Further, in some embodiments, the system may not include a separate processor and memory. Instead, in addition to performing their specific tasks, modules 375, 380, and 385, either separately or in concert, may be part of general- or special purpose computation engines.

Continuing with FIG. 5, storage 330 stores programs to be executed by processor 310. Specifically, storage 330 stores a program that implements a system (application) for reporting news using subscriber-specified JSDs. During operation, the application program can be loaded from storage 330 into memory 320 and executed by processor 310. As a result, system 300 can perform the functions described above. System 300 can be coupled to an optional display 360, keyboard 340, and pointing device 350, and can also be coupled via one or more network interfaces to network 370.

External data source module 375 may be configured to receive data from external data sources communicatively connected to system 300 via network 370. The node state module 380 maintains the current state of each of the nodes in a belief tree. The JSD processing module 385 processes the data received by the external data source module 375 and updates the state of the nodes in the node state module 380. In an embodiment of the present invention, if JSD criteria are met, the JSD processing module will notify a subscriber to the system 300 via network 370.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer readable storage medium, the computer system performs the methods and processes embodied as data structures and code and stored within the computer-readable storage medium. Furthermore, methods and processes described herein can be included in hardware modules or apparatus. These modules or apparatus may include, but are not limited to, an application-specific integrated circuit (ASIC) chip, a field programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The present invention is embodied in a software application running on a computer. It could be distributed over a network and downloaded on the user's machine, downloaded as a package to be programmatically interfaced by other applications, accessed through a URL as either an API or embedded application, compiled into other applications, downloaded as a stand-alone application, or executed by a computing device that can run the code.

The computer system may be in communication with one or more databases. The one or more databases may utilize any suitable database techniques. For instance, structured query language (SQL) or “NoSQL” database may be utilized for storing the map data, auditory data, user information and the like. Some of the databases may be implemented using various standard datastructures, such as an array, hash, (linked) list, structure, structured text file (e.g., XML), table, JSON, NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The present technology may be described in the general context of computer-executable instructions stored on computer readable medium that may be executed by a computer. However, one embodiment of the present technology may also utilize a distributed computing environment where tasks are performed remotely by devices linked through a communications network.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A computer executed method for the transmission of subscriber-specified just significant differences in a distributed system, said method comprising:
instantiating a tree data structure;
formulating a statement of belief at a root node of said tree data structure;
specifying just significant difference thresholds at each of a plurality of proximal subscriber nodes of said tree data structure;
establishing a subscription from said root node to each of said plurality of proximal subscriber nodes, wherein receipt of data at any of each said proximal subscriber nodes will cause said proximal subscriber node to evaluate said data and to forward said data to said root node if said just significant difference is satisfied;
specifying just significant difference at each of a plurality of leaf nodes of said tree data structure;
establishing subscriptions from each of said plurality of proximal subscriber nodes to one or more of said plurality of leaf nodes, wherein receipt of data at any of said leaf nodes will cause said leaf node to evaluate said data and to forward said data to each said subscribing proximal subscriber node if said just significant difference is satisfied; and
receiving said data at said leaf nodes from an external data source.

2. The method of claim 1, further comprising:
establishing a just significant difference at each of a plurality of distal subscriber nodes of said tree data structure;
establishing subscriptions from each of said plurality of proximal subscriber nodes to one or more of said plurality of distal subscriber nodes, wherein receipt of said data at any of said distal subscriber nodes will cause said distal subscriber node to evaluate said data and to forward said data to each said subscribing proximal subscriber node if said just significant difference is satisfied; and
establishing subscriptions from each of said plurality of distal subscriber nodes to one or more of said plurality of leaf nodes, wherein receipt of data at any of said leaf nodes will cause said leaf node to evaluate said data and forward said data to each said subscribing distal subscriber node if said just significant difference is satisfied.

3. The method of claim 1, further comprising:
establishing a just significant difference at a plurality of intermediate subscriber nodes of said tree data structure;
establishing subscriptions from each of said plurality of proximal subscriber nodes to one or more of said plurality of intermediate subscriber nodes, wherein receipt of data at any of said intermediate subscriber nodes will cause said intermediate subscriber node to evaluate said data and forward said data to each said subscribing proximal subscriber node if said just significant difference is satisfied; and
optionally, establishing subscriptions from each of said one or more intermediate subscriber nodes to one or more of said plurality of intermediate subscriber nodes which are not otherwise subscribed to, wherein receipt of data at any of said plurality of intermediate subscriber nodes which are not otherwise subscribed to will cause said intermediate subscriber node which is not otherwise subscribed to to evaluate said data and forward said data to each subscribing said one or more intermediate subscriber nodes if said just significant difference is satisfied;
establishing a just significant difference at a plurality of distal subscriber nodes of said tree data structure;
establishing subscriptions from each of said plurality of intermediate subscriber nodes which is not subscribing to another node to one or more of said plurality of distal subscriber nodes, wherein receipt of external data at any of said distal subscriber nodes will cause said distal subscriber node to evaluate said data and forward said data to each said subscribing intermediate subscriber node which is not subscribing to another node to one or more of said plurality of distal subscriber nodes if said just significant difference is satisfied; and
establishing subscriptions from each of said plurality of distal subscriber nodes to one or more of said plurality of leaf nodes, wherein receipt of external data at any of said leaf nodes will cause said leaf node to evaluate said external data and to and forward said data to each said subscribing distal subscriber node if said just significant difference is satisfied.

4. The method of claim 1, wherein two of said proximal nodes subscribe to one of said leaf nodes, further comprising establishing an algorithm at said one of said leaf nodes which allocates data sent between said two of said proximal nodes whereby duplicate data is not propagated through said tree data structure.

5. The method of claim 2, wherein one or more of said leaf nodes are each subscribed to by more than one of said proximal subscriber nodes, further comprising establishing an algorithm at each of said leaf nodes which allocates data sent between said subscribing proximal nodes whereby duplicate data is not propagated through said tree data structure.

6. The method of claim 3, wherein one or more of said distal nodes are each subscribed to by more than one of said intermediate subscriber nodes, further comprising establishing an algorithm at each of said distal nodes which allocates data sent between said subscribing intermediate nodes whereby duplicate data is not propagated through said tree data structure.

7. A system for the transmission of subscriber-specified just significant differences in a distributed system, said system comprising:
means for instantiating a tree data structure;
means for formulating a statement of belief at a root node of said tree data structure;
means for specifying just significant difference thresholds at each of a plurality of proximal subscriber nodes of said tree data structure;
means for establishing a subscription from said root node to each of said plurality of proximal subscriber nodes, wherein receipt of data at any of each said proximal subscriber nodes will cause said proximal subscriber node to evaluate said data and to forward said data to said root node if said just significant difference is satisfied;
means for specifying just significant difference at each of a plurality of leaf nodes of said tree data structure;
means for establishing subscriptions from each of said plurality of proximal subscriber nodes to one or more of said plurality of leaf nodes, wherein receipt of data at any of said leaf nodes will cause said leaf node to evaluate said data and to forward said data to each said subscribing proximal subscriber node if said just significant difference is satisfied; and
s for receiving said data at said leaf nodes from an external data source.

8. The system of claim 7, further comprising:
means for establishing a just significant difference at each of a plurality of distal subscriber nodes of said tree data structure;
means for establishing subscriptions from each of said plurality of proximal subscriber nodes to one or more of said plurality of distal subscriber nodes, wherein receipt of said data at any of said distal subscriber nodes will cause said distal subscriber node to evaluate said data and to forward said data to each said subscribing proximal subscriber node if said just significant difference is satisfied; and
s for establishing subscriptions from each of said plurality of distal subscriber nodes to one or more of said plurality of leaf nodes, wherein receipt of data at any of said leaf nodes will cause said leaf node to evaluate said data and forward said data to each said subscribing distal subscriber node if said just significant difference is satisfied.

9. The system of claim 7, further comprising:
means for establishing a just significant difference at a plurality of intermediate subscriber nodes of said tree data structure;
means for establishing subscriptions from each of said plurality of proximal subscriber nodes to one or more of said plurality of intermediate subscriber nodes, wherein receipt of data at any of said intermediate subscriber nodes will cause said intermediate subscriber node to evaluate said data and forward said data to each said subscribing proximal subscriber node if said just significant difference is satisfied;
onally, means for establishing subscriptions from each of said one or more intermediate subscriber nodes to one or more of said plurality of intermediate subscriber nodes which are not otherwise subscribed to, wherein receipt of data at any of said plurality of intermediate subscriber nodes which are not otherwise subscribed to will cause said intermediate subscriber node which is not otherwise subscribed to to evaluate said data and forward said data to each subscribing said one or more intermediate subscriber nodes if said just significant difference is satisfied;
means for establishing a just significant difference at a plurality of distal subscriber nodes of said tree data structure;
means for establishing subscriptions from each of said plurality of intermediate subscriber nodes which is not subscribing to another node to one or more of said plurality of distal subscriber nodes, wherein receipt of external data at any of said distal subscriber nodes will cause said distal subscriber node to evaluate said data and forward said data to each said subscribing intermediate subscriber node which is not subscribing to another node to one or more of said plurality of distal subscriber nodes if said just significant difference is satisfied; and
means for establishing subscriptions from each of said plurality of distal subscriber nodes to one or more of said plurality of leaf nodes, wherein receipt of external data at any of said leaf nodes will cause said leaf node to evaluate said external data and to and forward said data to each said subscribing distal subscriber node if said just significant difference is satisfied.

10. The system of claim 7, wherein two of said proximal nodes subscribe to one of said leaf nodes, further comprising means for establishing an algorithm at said one of said leaf nodes which allocates data sent between said two of said proximal nodes whereby duplicate data is not propagated through said tree data structure.

11. The system of claim 8, wherein one or more of said leaf nodes are each subscribed to by more than one of said proximal subscriber nodes, further comprising means for establishing an algorithm at each of said leaf nodes which allocates data sent between said subscribing proximal nodes whereby duplicate data is not propagated through said tree data structure.

12. The method of claim 9, wherein one or more of said distal nodes are each subscribed to by more than one of said intermediate subscriber nodes, further comprising means for establishing an algorithm at each of said distal nodes which allocates data sent between said subscribing intermediate nodes whereby duplicate data is not propagated through said tree data structure.

13. A computer program product for the transmission of subscriber-specified just significant differences in a distributed system, said computer program product comprising:
a computer readable storage medium; and
program on said computer readable storage medium for:
instantiating a tree data structure;
formulating a statement of belief at a root node of said tree data structure;
specifying just significant difference thresholds at each of a plurality of proximal subscriber nodes of said tree data structure;
establishing a subscription from said root node to each of said plurality of proximal subscriber nodes, wherein receipt of data at any of each said proximal subscriber nodes will cause said proximal subscriber node to evaluate said data and to forward said data to said root node if said just significant difference is satisfied;
specifying just significant difference at each of a plurality of leaf nodes of said tree data structure;
establishing subscriptions from each of said plurality of proximal subscriber nodes to one or more of said plurality of leaf nodes, wherein receipt of data at any of said leaf nodes will cause said leaf node to evaluate said data and to forward said data to each said subscribing proximal subscriber node if said just significant difference is satisfied; and
receiving said data at said leaf nodes from an external data source.

14. The computer program product of claim 13, further comprising:
establishing a just significant difference at each of a plurality of distal subscriber nodes of said tree data structure;
establishing subscriptions from each of said plurality of proximal subscriber nodes to one or more of said plurality of distal subscriber nodes, wherein receipt of said data at any of said distal subscriber nodes will cause said distal subscriber node to evaluate said data and to forward said data to each said subscribing proximal subscriber node if said just significant difference is satisfied; and
establishing subscriptions from each of said plurality of distal subscriber nodes to one or more of said plurality of leaf nodes, wherein receipt of data at any of said leaf nodes will cause said leaf node to evaluate said data and forward said data to each said subscribing distal subscriber node if said just significant difference is satisfied.

15. The computer program product of claim 13, further comprising:
establishing a just significant difference at a plurality of intermediate subscriber nodes of said tree data structure;
establishing subscriptions from each of said plurality of proximal subscriber nodes to one or more of said plurality of intermediate subscriber nodes, wherein receipt of data at any of said intermediate subscriber nodes will cause said intermediate subscriber node to evaluate said data and forward said data to each said subscribing proximal subscriber node if said just significant difference is satisfied;
optionally, establishing subscriptions from each of said one or more intermediate subscriber nodes to one or more of said plurality of intermediate subscriber nodes which are not otherwise subscribed to, wherein receipt of data at any of said plurality of intermediate subscriber nodes which are not otherwise subscribed to will cause said intermediate subscriber node which is not otherwise subscribed to to evaluate said data and forward said data to each subscribing said one or more intermediate subscriber nodes if said just significant difference is satisfied;
establishing a just significant difference at a plurality of distal subscriber nodes of said tree data structure;
establishing subscriptions from each of said plurality of intermediate subscriber nodes which is not subscribing to another node to one or more of said plurality of distal subscriber nodes, wherein receipt of external data at any of said distal subscriber nodes will cause said distal subscriber node to evaluate said data and forward said data to each said subscribing intermediate subscriber node which is not subscribing to another node to one or more of said plurality of distal subscriber nodes if said just significant difference is satisfied; and
establishing subscriptions from each of said plurality of distal subscriber nodes to one or more of said plurality of leaf nodes, wherein receipt of external data at any of said leaf nodes will cause said leaf node to evaluate said external data and to and forward said data to each said subscribing distal subscriber node if said just significant difference is satisfied.

16. The computer program product of claim 13, wherein two of said proximal nodes subscribe to one of said leaf nodes, further comprising establishing an algorithm at said one of said leaf nodes which allocates data sent between said two of said proximal nodes whereby duplicate data is not propagated through said tree data structure.

17. The computer program product of claim 14, wherein one or more of said leaf nodes are each subscribed to by more than one of said proximal subscriber nodes, further comprising establishing an algorithm at each of said leaf nodes which allocates data sent between said subscribing proximal nodes whereby duplicate data is not propagated through said tree data structure.

18. The computer program product of claim 15, wherein one or more of said distal nodes are each subscribed to by more than one of said intermediate subscriber nodes, further comprising establishing an algorithm at each of said distal nodes which allocates data sent between said subscribing intermediate nodes whereby duplicate data is not propagated through said tree data structure.
